(19) United States
(12) Patent Application Publication
(10) Pub. No.: US 2018/0275915 A1
(43) Pub. Date: Sep. 27, 2018

(54) METHODS FOR REGULAR AND GARBAGE-COLLECTION DATA ACCESS AND APPARATUSES USING THE SAME

(71) Applicant: Silicon Motion, Inc., Jhubei City (TW)

(72) Inventor: Kuan-Yu KE, Zhubei City (TW)

(21) Appl. No.: 15/863,898

(22) Filed: Jan. 6, 2018

(30) Foreign Application Priority Data
Mar. 22, 2017 (TW) 106109512

(51) Int. Cl. G06F 3/06

(52) U.S. Cl. CPC G06F 3/0652; G06F 3/0604; G06F 3/0656; G06F 3/0679; G06F 3/0608

(57) ABSTRACT

The invention introduces a method for regular and garbage-collection data access, performed by a processing unit, including at least the following steps: configuring a data buffer as a first type when performing a data access operation of a regular data access mode; and configuring the data buffer as a second type when performing a data access operation of a garbage-collection data access mode.

### CROSS REFERENCE TO RELATED APPLICATIONS

This Application claims priority of Taiwan Patent Application No. 106109512, filed on Mar. 22, 2017, the entirety of which is incorporated by reference herein.

### BACKGROUND

### Technical Field

The present invention relates to flash memory, and in particular to methods for regular and garbage-collection data access and apparatuses using the same.

### Description of the Related Art

Flash memory devices typically include NOR flash devices and NAND flash devices. NOR flash devices are random access—host accessing a NOR flash device can provide the device any address on its address pins and immediately retrieve data stored in that address on the device's data pins. NAND flash devices, on the other hand, are not random access but serial access. It is not possible for NOR to access any random address in the way described above. Instead, the host has to write into the device a sequence of bytes which identifies both the type of command requested (e.g. read, write, erase, etc.) and the address to be used for that command. The address identifies a page (the smallest chunk of flash memory that can be written in a single operation) or a block (the smallest chunk of flash memory that can be erased in a single operation), and not a single byte or word. In reality, the NAND flash device always reads from the memory cells and writes to the memory cells complete pages. After a page of data is read from the array into a buffer inside the device, the host can access the data bytes or words one by one by serially clocking them out using a strobe signal.

If the data in some of the units of a page are no longer needed (such units are also called stale units), only the units with good data in that page are read and rewritten into another previously erased empty block. Then the free units and the stale units are available for new data. This is a process called GC (garbage collection). The process of garbage collection involves reading data from the flash memory and rewriting data to the flash memory. It means that a flash controller first requires a read of the whole page, and then a write of the parts of the page which still include valid data. However, a data buffer may need to reserve space for regular and GC data access. Accordingly, what is needed are methods for regular and garbage-collection data access and apparatuses that use these methods to use the space of the data buffer efficiently.

### BRIEF SUMMARY

An embodiment of the invention introduces a method for regular and garbage-collection data access, performed by a processing unit, including at least the following steps: configuring a data buffer as a first type when performing a data access operation of a regular data access mode; and configuring the data buffer as a second type when performing a data access operation of a garbage-collection data access mode.

An embodiment of the invention introduces an apparatus for garbage collection including at least a data buffer and a processing unit. The processing unit, coupled to the data buffer, configures the data buffer as a first type when performing a data access operation of a regular data access mode; and configures the data buffer as a second type when performing a data access operation of a garbage-collection data access mode.

A detailed description is given in the following embodiments with reference to the accompanying drawings.

### BRIEF DESCRIPTION OF THE DRAWINGS

The present invention can be fully understood by reading the subsequent detailed description and examples with references made to the accompanying drawings, wherein:

FIG. 1 is the system architecture of a flash memory according to an embodiment of the invention.

FIG. 2 is a schematic diagram illustrating interfaces to storage units of a flash storage according to an embodiment of the invention.

FIG. 3 is a schematic diagram depicting connections between one access sub-interface and multiple storage sub-units according to an embodiment of the invention.

FIG. 4A is a schematic diagram illustrating the buffer allocation in the regular data access mode according to an embodiment of the invention.

FIG. 4B is a schematic diagram illustrating the buffer allocation in the garbage-collection data access mode according to an embodiment of the invention.

FIG. 5 is a schematic diagram of GC (Garbage Collection) according to an embodiment of the invention.

FIG. 6 is a flowchart illustrating a method for a mode selection according to an embodiment of the invention.

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

The present invention will be described with respect to particular embodiments and with reference to certain drawings, but the invention is not limited thereto and is only limited by the claims. It should be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

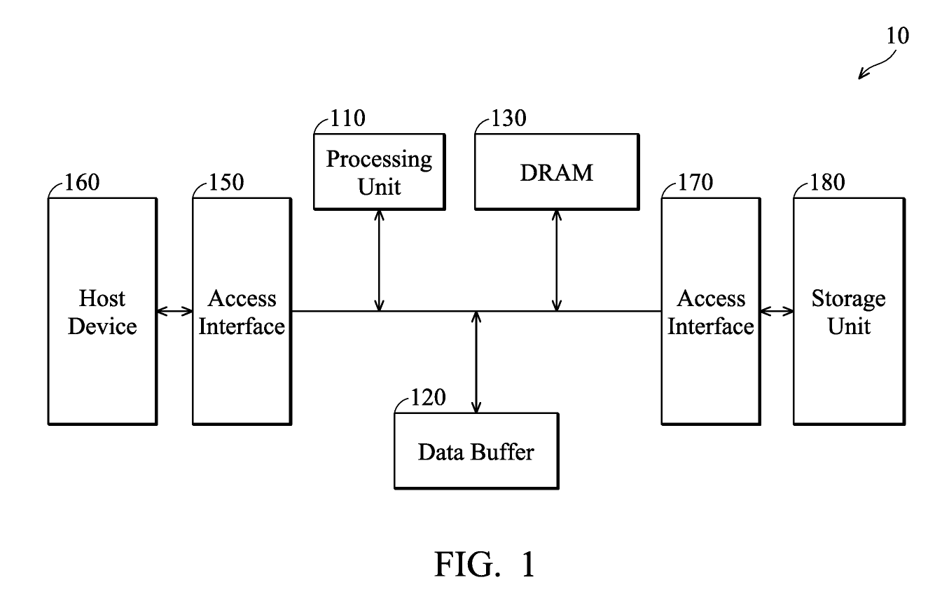

FIG. 1 is the system architecture of a flash memory according to an embodiment of the invention. The system architecture 10 of the flash memory contains a processing unit 110 being configured to write data into a designated address of a storage unit 180, and read data from a designated address thereof. Specifically, the processing unit 110 writes data into a designated address of the storage unit 180 through an access interface 170 and reads data from a designated address thereof through the same interface 170. The system architecture 10 uses several electrical signals for coordinating commands and data transfer between the processing unit 110 and the storage unit 180, including data lines, a clock signal and control lines. The data lines are employed to transfer commands, addresses and data to be written and read. The control lines are utilized to issue control signals, such as CE (Chip Enable), ALE (Address Latch Enable), CLE (Command Latch Enable), WE (Write Enable), etc. The access interface 170 may communicate with the storage unit 180 using a SDR (Single Data Rate) protocol or a DDR (Double Data Rate) protocol, such as ONFI (open NAND flash interface), DDR toggle, or others. The processing unit 110 may communicate with the host device 160 through an access interface 150 using a standard protocol, such as USB (Universal Serial Bus), ATA (Advanced Technology Attachment), SATA (Serial ATA), PCI-E (Peripheral Component Interconnect Express) or others.

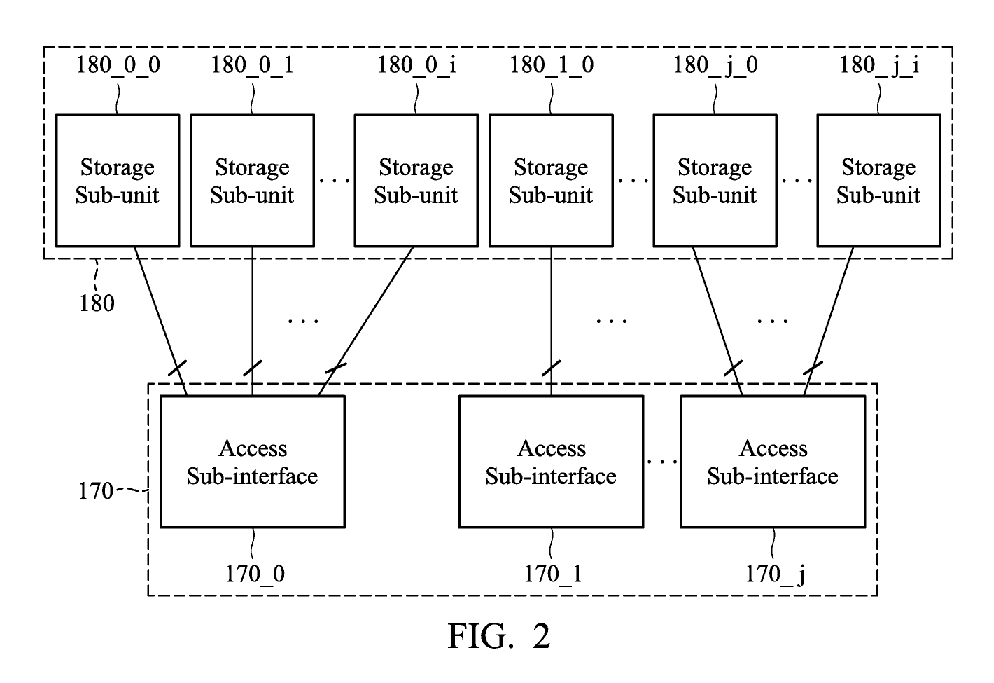

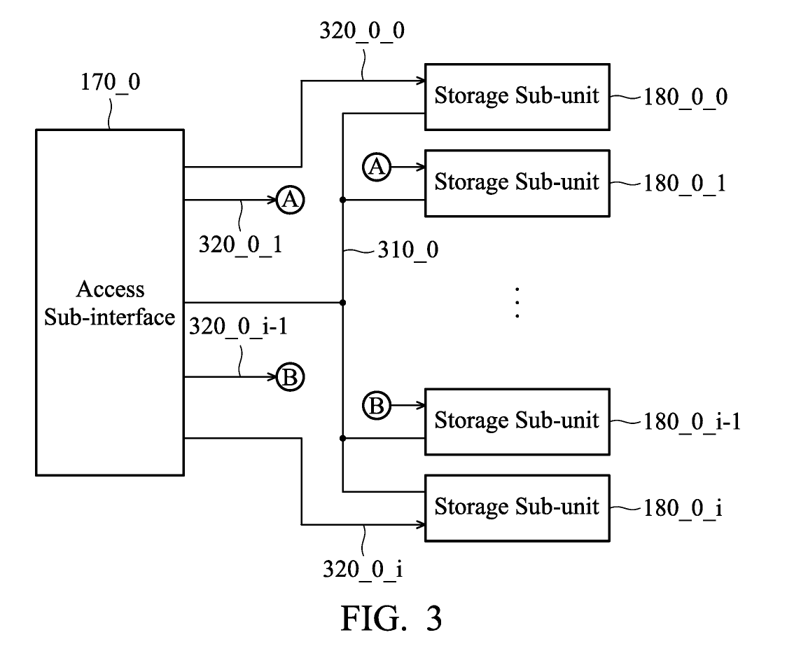

The storage unit 180 may contain multiple storage sub-units and each storage sub-unit may be practiced in a single die and use an access sub-interface to communicate with the processing unit 110. FIG. 2 is a schematic diagram illustrating interfaces to storage units of a flash storage according to an embodiment of the invention. The flash memory 10 may contain j+1 access sub-interfaces 170_0 to 170_j, where the access sub-interfaces may be referred to as channels, and each access sub-interface connects to i+1 storage sub-units. That is, i+1 storage sub-units may share the same access sub-interface. For example, assume that the flash memory contains 4 channels (j=3) and each channel connects to 4 storage sub-units (i=3): The flash memory 10 has 16 storage sub-units 180_0_0 to 180_j_i in total. The control unit 110 may direct one of the access sub-interfaces 170_0 to 170_j to read data from the designated storage sub-unit. Each storage sub-unit has an independent CE control signal. That is, it is required to enable a corresponding CE control signal when attempting to perform data read from a designated storage sub-unit via an associated access sub-interface. It is apparent that any number of channels may be provided in the flash memory 10, and each channel may be associated with any number of storage sub-units, and the invention should not be limited thereto. FIG. 3 is a schematic diagram depicting connections between one access sub-interface and multiple storage sub-units according to an embodiment of the invention. The processing unit 110, through the access sub-interface 170_0, may use independent CE control signals 320_0_0 to 320_0_i to select one of the connected storage sub-units 180_0_0 and 180_0_i, and then read data from the designated location of the selected storage sub-unit via the shared data line 310_0.

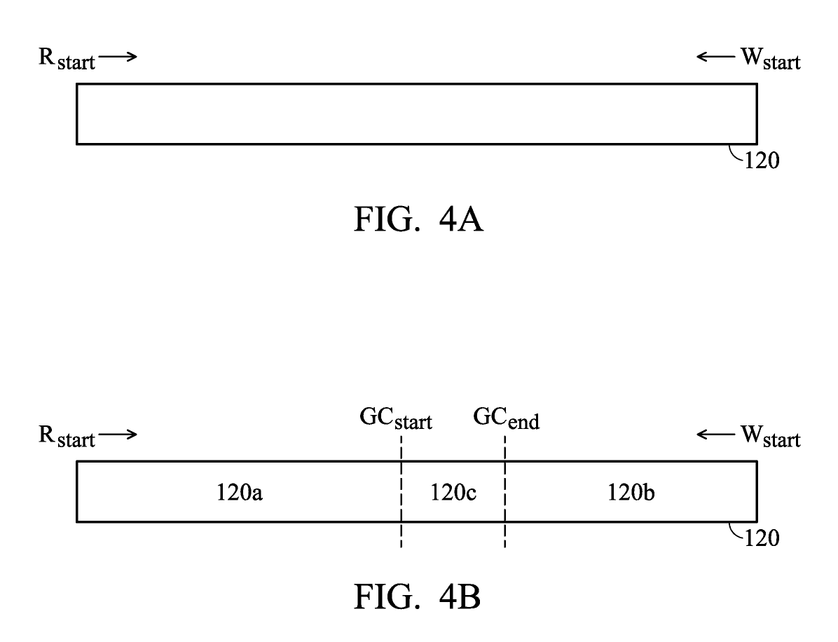

Embodiments of the invention introduce methods for regular and garbage-collection data access to allocate space of a data buffer 120 for regular and garbage-collection reads and writes dynamically. In some embodiments, the data buffer 120 may be implemented in a DRAM (Dynamic Random Access Memory) 130. Space of the data buffer 120 may be configured in two modes: regular data access; and garbage-collection data access. FIG. 4A is a schematic diagram illustrating the buffer allocation in the regular data access mode according to an embodiment of the invention. In the regular data access mode, space of the data buffer 120 is allocated to store data needed for regular data accesses; that is, for data read and write commands issued by the host device 160. The lowest address of the data buffer 120 is denoted as Rₛₜₐᵣₜ while the highest address of the data buffer 120 is denoted as Wₛₜₐᵣₜ. The data buffer 120 is a bi-directional ring buffer including a read buffer and a write buffer with variable lengths. Initially, the addresses of the read buffer ranges from the lowest address Rₛₜₐᵣₜ of the data buffer 120 to higher addresses and the addresses of the write buffer ranges from the highest address Wₛₜₐᵣₜ of the data buffer 120 to lower addresses. A boundary address between the read buffer and the write buffer may be dynamically determined according to lengths of data that needs to be buffered for the data read and write commands. For example, when detecting that the length of data that needs to be buffered for the read commands is longer than the length of data that needs to be buffered for the write commands, the processing unit 110 sets the boundary address being closer to the highest address Wₛₜₐᵣₜ than the lowest address Rₛₜₐᵣₜ. Otherwise, the processing unit 110 sets the boundary address being closer to the lowest address Rₛₜₐᵣₜ than the highest address Wₛₜₐᵣₜ. After receiving a read command from the host device 160 via the access interface 150, the processing unit 110 converts a logical location of the read command into a physical location, directs the access interface 170 to read data from the physical location of the storage unit 180 and stores the read data in the read buffer. The read data (that is, data is to be clocked out to the host device 160) is stored from a lower address of the read buffer to a higher address thereof. After receiving a write command from the host device 160 via the access interface 150, the processing unit 110 stores the data of the write command that is to be programmed into the storage unit 180 in the write buffer. The data to be written is stored from a higher address of the write buffer to a lower address thereof. Those skilled in the art may access data of the read buffer and the write buffer with variable lengths in a well-known method and the access method is omitted for brevity. FIG. 4B is a schematic diagram illustrating the buffer allocation in the garbage-collection data access mode according to an embodiment of the invention. The data buffer 120 may be segmented into three parts: a read buffer 120a (whose addresses range from Rₛₜₐᵣₜ to GCₛₜₐᵣₜ₋₁); a GC (Garbage Collection) buffer 120c (whose addresses range from GCₛₜₐᵣₜ to GC_{end}); and a write buffer 120b (whose addresses range from Wₛₜₐᵣₜ to GC_{end+i}). In the garbage-collection data access mode, space of the data buffer 120 is allocated to store data needed for regular data accesses; that is, for data read and write commands issued by the host device 160, and data needed for a GC process. In the garbage-collection data access mode, the read data corresponding to the first read command issued by the host device 160 is stored from the address Rₛₜₐᵣₜ of the data buffer 120 to a higher address and the data to be programmed that corresponds to the first write command issued by the host device 160 is stored from the address Wₛₜₐᵣₜ of the data buffer 120 to a lower address. In addition, in the garbage-collection data access mode, instructions of the GC process are executed to direct the access interface 170 to read data of pages from the storage unit 180, collect good data from the read data and direct the access interface 170 to program the good data into spare blocks of the storage unit 180. In the garbage-collection data access mode, space between the addresses GCₛₜₐᵣₜ and GC_{end} of the data buffer 120 is allocated to store the good data.

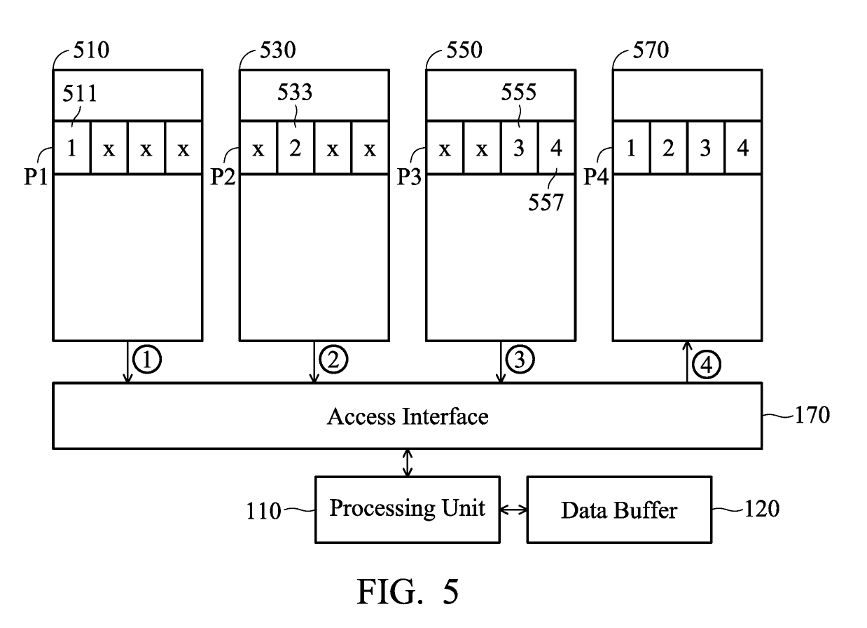

FIG. 5 is a schematic diagram of GC according to an embodiment of the invention. Assume one page stores data of four sections: Through being accessed several times, the 0^{th} section 511 of the page P1 of the block 510 contains good data and the other sections contain stale data. The 1^{st} section 533 of the page P2 of the block 530 contains good data and the other sections contain stale data. The 2^{nd} and 3^{rd} sections 555 and 557 of the page P3 of the block 550 contain good data and the other sections contain stale data. In order to collect good data of the pages P1 to P3 in one page so as to store the good data in a new page P4 of the block 570, the GC process is performed. Specifically, space of the data buffer 120 is allocated to store one page of data. The processing unit 110 may read data of the page P1 from the block 510 via the access interface 170, hold data of the 0^{th} section 511 of the page P1 and store it in the 0^{th} section of the allocated space of the data buffer 120). Next, the processing unit 110 may read data of the page P2 from the block 530 via the access interface 170, hold data of the 1^{st} section 533 of the page P2 and store it in the 1^{st} section of the allocated space of the data buffer 120. Next, the processing unit 110 may read data of the page P3 from the block 550 via the access interface 170, hold data of the 2^{nd} and 3^{rd} sections 555 and 557 of the page P3 and store it in the 2^{nd} and 3^{rd} section of the allocated space of the data buffer 120. Finally, the processing unit 110 may program data of the allocated space of the data buffer 120 into the page P4 of the block 570.

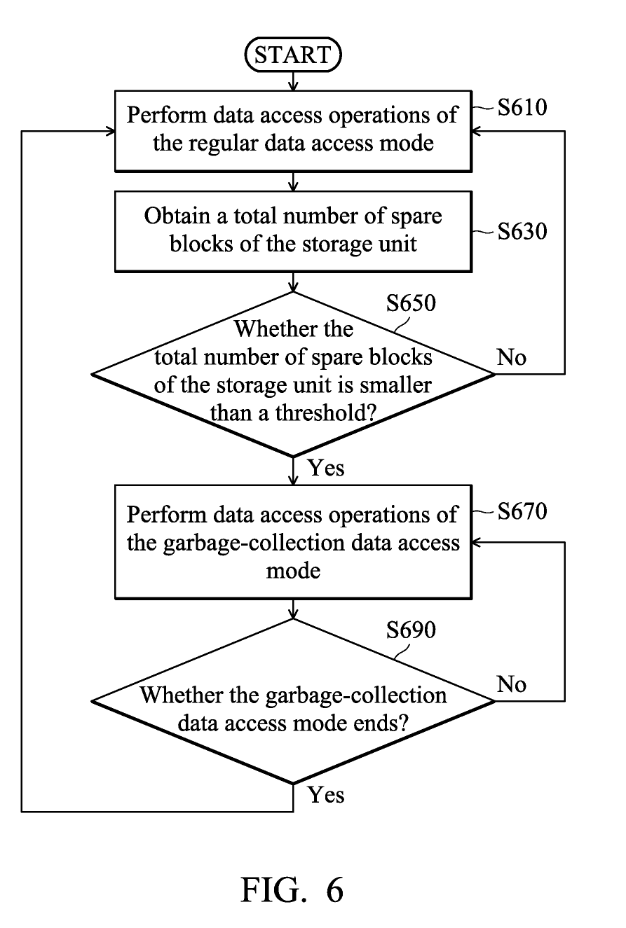

The DRAM 130 stores a flag to indicate which of the regular and garbage-collection data access modes the flash memory is in. For example, the flag of “0” indicates that the flash memory is currently in the regular data access mode. The flag of “1” indicates that the flash memory is currently in the garbage-collection mode. FIG. 6 is a flowchart illustrating a method for a mode selection according to an embodiment of the invention. The method is performed when relevant microcode, macrocode or software instructions are loaded and executed by the processing unit 110. After data access operations of the regular data access mode are performed completely (step S610), a total number of spare blocks of the storage unit 180 is obtained (step S630) and it is determined whether the total number of spare blocks of the storage unit 180 is smaller than a threshold (step S650). In step S610, the processing unit 110 may set the flag of the DRAM 130 to indicate that the flash memory is currently in the regular data access mode. The data buffer 120 may be configured as the type as shown in FIG. 4A. In step S610, the processing unit 110 may perform the data access operations of the regular data access mode for a predefined time period. In alternative embodiments, the processing unit 110 may perform a predefined data volume of the data access operations of the regular data access mode. In alternative embodiments, the processing unit 110 may perform a predefined number of transactions of the data access operations of the regular data access mode. When the total number of spare blocks of the storage unit 180 is smaller than the threshold (the “Yes” path of step S650), data access operations of the garbage-collection data access mode are performed (step S670). After data access operations of the garbage-collection data access mode are performed (step S670), it is determined whether the garbage-collection data access mode ends (step S690). When the garbage-collection data access mode ends (the “Yes” path of step S690), the data access operations of the regular data access mode are performed (step S610). In step S670, the processing unit 110 may set the flag of the DRAM 130 to indicate that the flash memory is currently in the garbage-collection data access mode. The data buffer 120 may be configured as the type as shown in FIG. 4B. In step S670, the processing unit 110 may perform the data access operations of the garbage-collection data access mode for a predefined time period. In alternative embodiments, the processing unit 110 may perform a predefined data volume of the data access operations of the garbage-collection data access mode. In alternative embodiments, the processing unit 110 may perform a predefined number of transactions of the data access operations of the garbage-collection data access mode.

In the regular data access mode (step S610), the processing unit 110 uses a read pointer and a write pointer to access data corresponding to the read command issued by the host device 160, also referred to as the read pointer and the write pointer corresponding to the read command. Moreover, the processing unit 110 uses a read pointer and a write pointer to access data corresponding to the write command issued by the host device 160, also referred to as the read pointer and the write pointer corresponding to the write command.

In the garbage-collection data access mode (step S670), the read buffer 120a, the GC buffer 120c and the write buffer 120b are configured as ring buffers. The processing unit 110 uses a read pointer and a write pointer to access data of the read buffer 120a. The read pointer points to the begin address of the read buffer 120a storing data of the first page that hasn't been clocked out to the host device 160. The write pointer points to the begin address of spare space of the read buffer 120a. In response to the read command issued by the host device 160, the processing unit 110 reads data of several pages from the storage unit 180, stores the read data in the read buffer 120a and clocks the read data of the read buffer 120a page by page out to the host device 160. Specifically, after reading one page of data requested by the host device 160 and storing the read data in the read buffer 120a, the processing unit 110 moves the write pointer to the address next to the stored data and determines whether the write pointer points to the address range of the GC buffer 120c. If so, the processing unit 110 moves the write pointer to the address Rₛₜₐᵣₜ of the read buffer 120a. The processing unit 110 may read at least one page of data from the address of the read buffer 120a pointed to by the read pointer, clock the read data out to the host device 160, move the read pointer to point to the address next to the read data of the read buffer 120a, and then, determine whether the read pointer points to the address range of the GC buffer 120c. If so, the processing unit 110 moves the read pointer to point to the address Rₛₜₐᵣₜ of the read buffer 120a.

In the garbage-collection data access mode (step S670), the processing unit 110 uses a read pointer and a write pointer to access data of the write buffer 120b. The read pointer points to the begin address of the write buffer 120b storing data of the first page that hasn't been programmed into the storage unit 180. The write pointer points to the begin address of spare space of the write buffer 120b. In response to the write command issued by the host device 160, the processing unit 110 stores data transmitted by the host device 160 in the write buffer 120b, reads data from the write buffer 120b and programs the read data page by page into the storage unit 180. Specifically, after obtaining one page of data from the host device 160 and storing the read data in the address of the write buffer 120b pointed to by the write pointer, the processing unit 110 moves the write pointer to the address prior to the stored data and determines whether the write pointer points to the address range of the GC buffer 120c. If so, the processing unit 110 moves the write pointer to the address Wₛₜₐᵣₜ of the write buffer 120b. The processing unit 110 may read at least one page of data from the address of the write buffer 120b pointed to by the read pointer, program the read data into the storage unit 180, move the read pointer to point to the address prior to the read data of the write buffer 120b, and then determine whether the read pointer points to the address range of the GC buffer 120c. If so, the processing unit 110 moves the read pointer to point to the address Wₛₜₐᵣₜ of the write buffer 120b.

In the garbage-collection data access mode (step S670), the processing unit 110 uses a read pointer and a write pointer to access data of the GC buffer 120c. The read pointer points to the begin address of the GC buffer 120c storing data of the first page that hasn't been programmed into the storage unit 180. The write pointer points to the begin address of spare space of the GC buffer 120c. The processing unit 110 stores good data to be programmed in the GC buffer 120c, reads the good data from the GC buffer 120c and programs the read data page by page into the storage unit 180. Specifically, after collecting one page of good data from the storage unit 180 and storing the collected data in the address of the GC buffer 120c pointed to by the write pointer, the processing unit 110 moves the write pointer to the address next to the stored data and determines whether the write pointer points to the address range of the write buffer 120b. If so, the processing unit 110 moves the write pointer to the address GCₛₜₐᵣₜ of the GC buffer 120c. The processing unit 110 may read at least one page of good data from the address of the GC buffer 120c pointed to by the read pointer, program the read data into the storage unit 180, move the read pointer to point to the address next to the read data of the GC buffer 120c, and then, determine whether the read pointer points to the address range of the write buffer 120b. If so, the processing unit 110 moves the read pointer to the address GCₛₜₐᵣₜ of the GC buffer 120c.

Although the embodiment has been described as having specific elements in FIGS. 1 to 3, it should be noted that additional elements may be included to achieve better performance without departing from the spirit of the invention. While the process flow described in FIG. 6 includes a number of operations that appear to occur in a specific order, it should be apparent that these processes can include more or fewer operations, which can be executed serially or in parallel (e.g., using parallel processors or a multi-threading environment).

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for regular and garbage-collection data access, performed by a processing unit, comprising:
configuring a data buffer as a first type when performing a data access operation of a regular data access mode; and
configuring the data buffer as a second type when performing a data access operation of a garbage-collection data access mode.

2. The method of claim 1, wherein the data buffer of the first type stores data corresponding to a read command and a write command issued by a host device, and the data buffer of the second type stores the data corresponding to the read command and the write command issued by the host device and data corresponding to a GC (garbage collection) process.

3. The method of claim 2, wherein the GC process directs an access interface to read a plurality of pages of data from a storage unit, collects good data of the read data, stores the good data in the data buffer of the second type and directs the access interface to read the good data from the data buffer of the second type and program the read data into a spare block of the storage unit.

4. The method of claim 1, wherein the data buffer of the first type comprises a read buffer and a write buffer with variable lengths.

5. The method of claim 4, wherein, in the data access operation of the regular data access mode, the processing unit stores data to be clocked out to a host device from a lower address to a higher address of the read buffer, and data to be programmed into a storage unit from a higher address to a lower address of the write buffer.

6. The method of claim 1, wherein the data buffer of the second type comprises a read buffer, a garbage-collection buffer and a write buffer.

7. The method of claim 6, wherein, in the data access operation of the garbage-collection data access mode, the processing unit stores data to be clocked out to a host device from a lower address to a higher address of the read buffer, data to be programmed into a storage unit from a higher address to a lower address of the write buffer, and data corresponding to a GC process in the GC buffer.

8. The method of claim 1, comprising:
obtaining a total number of spare blocks of a storage unit and determining whether the total number of spare blocks of the storage unit is lower than a threshold after performing the data access operation of the regular data access mode; and
performing the data access operation of the garbage-collection data access mode when the total number of spare blocks of the storage unit is lower than the threshold.

9. The method of claim 1, comprising:
determining whether the garbage-collection data access mode ends after performing the data access operation of the garbage-collection data access mode; and
performing the data access operation of the regular data access mode when the garbage-collection data access mode ends.

10. An apparatus for garbage collection, comprising:
a data buffer; and
a processing unit, coupled to the data buffer, configuring the data buffer as a first type when performing a data access operation of a regular data access mode; and configuring the data buffer as a second type when performing a data access operation of a garbage-collection data access mode.

11. The apparatus of claim 10, wherein the data buffer of the first type stores data corresponding to a read command and a write command issued by a host device, and the data buffer of the second type stores the data corresponding to the read command and the write command issued by the host device and data corresponding to a GC (garbage collection) process.

12. The apparatus of claim 11, comprising:
an access interface, coupled to a storage unit;
wherein the GC process directs the access interface to read a plurality of pages of data from the storage unit, collects good data of the read data, stores the good data in the data buffer of the second type and directs the access interface to read the good data from the data buffer of the second type and program the read data into a spare block of the storage unit.

13. The apparatus of claim 10, wherein the data buffer of the first type comprises a read buffer and a write buffer with variable lengths.

14. The apparatus of claim 13, wherein, in the data access operation of the regular data access mode, the processing unit stores data to be clocked out to a host device from a lower address to a higher address of the read buffer, and data to be programmed into a storage unit from a higher address to a lower address of the write buffer.

15. The apparatus of claim 10, wherein the data buffer of the second type comprises a read buffer, a garbage-collection buffer and a write buffer.

16. The apparatus of claim 15, wherein, in the data access operation of the garbage-collection data access mode, the processing unit stores data to be clocked out to a host device from a lower address to a higher address of the read buffer, data to be programmed into a storage unit from a higher address to a lower address of the write buffer, and data corresponding to a GC process in the GC buffer.

17. The apparatus of claim 10, wherein the processing unit obtains a total number of spare blocks of a storage unit and determines whether the total number of spare blocks of the storage unit is lower than a threshold after performing the data access operation of the regular data access mode; and performs the data access operation of the garbage-collection data access mode when the total number of spare blocks of the storage unit is lower than the threshold.

18. The apparatus of claim 10, wherein the processing unit determines whether the garbage-collection data access mode ends after performing the data access operation of the garbage-collection data access mode; and performs the data access operation of the regular data access mode when the garbage-collection data access mode ends.
